(19) United States
(12) Patent Application Publication
(10) Pub. No.: US 2016/0259421 A1
(43) Pub. Date: Sep. 8, 2016

(54) DEVICES, SYSTEMS, AND METHODS FOR CONTROLLING DEVICES USING GESTURES

(71) Applicant: UNIVERSITY OF WASHINGTON THROUGH ITS CENTER FOR COMMERCIALIZATION, Seattle, WA (US)

(72) Inventors: Shyamnath Gollakota, Seattle, WA (US); Bryce Kellogg, Seattle, WA (US); Vamsi Talla, Seattle, WA (US); Rajalakshmi Nandakumar, Seattle, WA (US)

(73) Assignee: UNIVERSITY OF WASHINGTON THROUGH ITS CENTER FOR COMMERCIALIZATION, Seattle, WA (US)

(21) Appl. No.: 15/028,402

(22) PCT Filed: Oct. 8, 2014
(86) PCT No.: PCT/US14/59750

§ 371 Date: Apr. 8, 2016

Related U.S. Application Data
(60) Provisional application No. 61/888,403, filed on Oct. 8, 2013.
(60) Provisional application No. 61/941,973, filed on Feb. 19, 2014.
(60) Provisional application No. 61/953,092, filed on Mar. 14, 2014.
(60) Provisional application No. 62/013,748, filed on Jun. 18, 2014.

(51) Int. Cl. G06F 3/01; H04M 1/725; H04W 24/02; G06F 3/16

(52) U.S. Cl. CPC G06F 3/017; G06F 3/165; H04M 1/72558; H04W 24/02

(57) ABSTRACT

Example devices, systems, and methods described herein extract gesture information from wireless signals. Examples described herein may extract gesture information from changes in the magnitude of the amplitude of the received wireless signals, or portions of the received wireless signals (e.g., channel state information, RSSI information, RCPI information). Time-domain classification of gestures may proceed based on the amplitude changes. In this manner, sufficiently low power operation may be achieved to enable “through-the-pocket” gesture recognition on mobile devices in some examples.

### CROSS REFERENCE TO RELATED APPLICATION(S)

This application claims benefit under 35 U.S.C. 119(e) to U.S. provisional patent application Ser. No. 61/888,403, entitled “ULTRA-LOW POWER GESTURE RECOGNITION” filed Oct. 8, 2013, which provisional application is incorporated herein by reference in its entirety for any purpose.

This application claims benefit under 35 U.S.C. 119(e) to U.S. provisional patent application Ser. No. 61/941,973, entitled “SYSTEM AND METHOD FOR GESTURE RECOGNITION” filed Feb. 19, 2014, which provisional application is incorporated herein by reference in its entirety for any purpose.

This application claims benefit under 35 U.S.C. 119(e) to U.S. provisional patent application Ser. No. 61/953,092, entitled “DEVICES, SYSTEMS, AND METHODS FOR CONTROLLING DEVICES USING GESTURES” filed Mar. 14, 2014, which provisional application is incorporated herein by reference in its entirety for any purpose.

This application claims benefit under 35 U.S.C. 119(e) to U.S. provisional patent application Ser. No. 62/013,748, entitled “ULTRA-LOW POWER GESTURE RECOGNITION USING WIRELESS SIGNALS (ALLSEE)” filed Jun. 18, 2014, which provisional application is incorporated herein by reference in its entirety for any purpose.

### TECHNICAL FIELD

Examples described herein relate to detection of gestures. Examples of controlling devices using gestures are described, including “through-the-pocket” detection of gestures for control of a device.

### BACKGROUND

Electronic devices may be configured to recognize gestures, as exemplified, for example by the XBox Kinect device. Gesture recognition systems typically utilize a significant amount of power and/or processing complexity and are accordingly used in plugged-in systems such as gaming consoles or routers. For example, always-on cameras may significantly drain batteries and power-intensive components such as oscillators and high-speed ADCs may be used. Moreover, significant processing capability—for example to compute FFTs or optical flows, may be needed to recognize the gestures. These operations also require a significant amount of power.

### SUMMARY

Example devices are disclosed herein. An example advice may a receiver configured to receive wireless signals and provide an indication of magnitude changes of amplitude of the wireless signals over time. The example device may further include a classifier configured to identify an associated gesture based on the indication of the magnitude changes of amplitude of the wireless signals over time. The example device may further include at least one processing unit configured to provide a response to the indication of the associated gesture.

Another example device may include a receiver configured extract an amplitude of a wireless signal over time, and a classifier configured to detect: changes in the amplitude of the wireless signal over time. The classifier may he further configured to identify a gesture corresponding to the changes in the amplitude of the wireless signal over time.

Examples of methods are described herein. An example method may include performing a gesture selected to control a device, and receiving, using the device, wireless signals. The example method may further include analyzing, using the device, magnitude changes in amplitude of the wireless signals indicative of the gesture and responding to the gesture, using the device.

### BRIEF DESCRIPTION OF THE DRAWINGS

FIG. 1 is a schematic illustration of a device arranged in accordance with examples of the present disclosure.

FIG. 2 is a schematic illustration of a device arranged in accordance with examples of the present disclosure.

FIG. 3 is a flowchart of a method in accordance with examples of the present disclosure.

FIG. 4A-H are schematic illustrations of gestures which may be decoded by devices in accordance with examples of the present disclosure.

FIG. 5 is a schematic illustration of an example receiver arranged in accordance with examples of the present disclosure.

FIG. 6A-H are illustrations of amplitude information associated with gestures extracted from wireless signals in accordance with examples of the present disclosure.

FIG. 7 is a schematic illustration of an analog circuit that can distinguish between two gestures, arranged in accordance with examples of the present disclosure.

### DETAILED DESCRIPTION

Certain details are set forth below to provide a sufficient understanding of embodiments of the disclosure. However, it will be clear to one skilled in the art that embodiments of the disclosure may be practiced without various of these particular details. In some instances, well-known device components, circuits, control signals, timing protocols, and software operations have not been shown in detail in order to avoid unnecessarily obscuring the described embodiments of the disclosure.

Example devices, systems, and methods described herein extract gesture information from wireless signals (e.g., ambient RF signals such as TV transmissions or WiFi signals that may already exist around the device). Wireless signals from dedicated RF sources like RFID readers may also be used. Examples described herein may reduce or eliminate a need for power-hungry wireless hardware components (e.g., oscillators) by using low-power analog operations to extract signal amplitude. To keep the computational complexity low, examples described herein may not need to utilize FFT computations (such as may be used in Doppler-based approaches) or optical flow computations. Examples described herein may extract gesture information from the amplitude of the received wireless signals.

Some discussion of the theory of operation of example devices is provided herein. The discussion is not intended to be limiting, but is provided to facilitate understanding of certain examples. It is to be understood that not all examples may operate in accordance with the described theories. Generally, motion at a location farther from a receiver results in smaller wireless signal changes than from a close-by location. This is because the reflections from a farther location experience higher attenuation and hence have lower energy at the receiver. As a user moves her arm toward the receiver while making a gesture, the wireless signal changes induced by the gesture increase with time, as the arm gets closer to the receiver. On the other hand, as the user moves her arm away from the receiver, the changes decrease with time. Thus, the receiver can distinguish between a pull and a push gesture even without access to phase information, such as used in developing Doppler information.

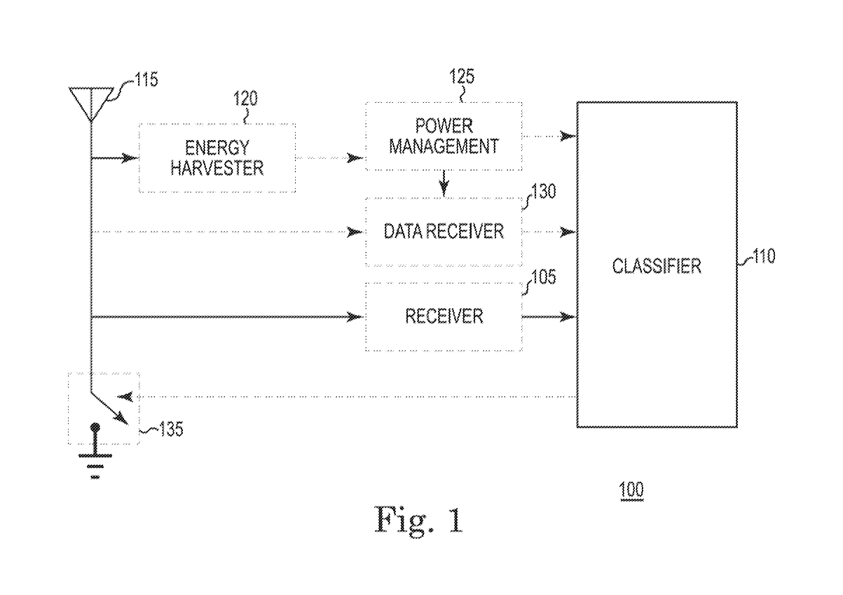

FIG. 1 is a schematic illustration of a device 100 arranged in accordance with examples of the present disclosure. The device 100 includes an antenna 115, receiver 105, and classifier 110. The device 100 may also in some examples include an energy harvester 120, power management unit 125, data receiver 130, and/or data transmitter 135. The device 100 may be implemented in any electronic device having the described components including, but not limited to, mobile devices such as cellular telephones, smartphones, tablets, and laptops. The device 100 may further be implemented in generally any electronic device including but not limited to computers, routers, gaming systems, set-top boxes, sensor hubs, amplifiers, appliances, or televisions.

The antenna 115 may generally receive wireless signals. In some examples, the antenna 115 may represent multiple antennas to receive multiple wireless signals, one or more of which may be analyzed for gesture detection. For example, each antenna may he designed to receive signals transmitted within a particular frequency range or ranges, or for a particular purpose (e.g., TV, cellular, WiFi, etc.). Generally, any wireless signals may be used, and the wireless signals are generally non-optical signals (e.g., a camera or image sensor is not used to receive the wireless signals). Examples of wireless signals include, but are not limited to, Wi-Fi signals, cellular signals, radio frequency (RF) signals (e.g., television signals or RFID reader signals), sound signals, ultrasound signals, and combinations of two or more of these signals. The wireless signals may include a periodically transmitted signal (e.g., a pilot or beacon signal) or an intermittently transmitted signal (e.g., a WiFi signal). In some examples, the periodically transmitted signals (e.g., pilot or beacon signals) or these intermittently transmitted signals (e.g., a WiFi signals) that are analyzed for amplitude changes indicative of gestures. In some examples, the wireless signals include channel state information, such as received signal strength information (RSSI information), present in typical cellular communications and/or in WiFi communications. In some examples, received channel power indicator (RCPI information) in wireless signals may be used to analyze amplitude changes indicative of gestures. In some examples, it is the channel state information that is analyzed for amplitude changes indicative of gestures. In some examples, the channel state information may also be analyzed for phase changes, in combination with or in addition to amplitude changes, indicative of gestures. Full channel state information, such as available through IEEE standard 802.11, may be used, or just RSSI or RCPI information. The wireless signals may be constant wave transmissions (e.g., RFID), faster-changing transmissions (e.g., TV signals), or intermittent transmissions (e.g., WiFi signals). In some examples, the wireless signals may be ambient wireless signals which are already present in the environment of the device 100, such as those transmitted from a base station (e.g., WiFi, TV, cellular, etc.). That is, wireless signals which are already being received by the device may be used. In some examples, the wireless signals may be transmitted from a dedicated signal source (not shown) or from the device 100, itself, such as via the antenna 115. The wireless signals transmitted from the dedicated signal source or from the device 100 may be for the purpose of signal detection or may be for another purpose (e.g., cellular communications, WiFi communications, or other communications).

The receiver 105 may receive the wireless signals from the antenna 115 and may provide an indication of changes of amplitude of the wireless signals over time. The receiver 105 may include an envelope detector for extracting the amplitude of the wireless signals. The receiver 105 may be an additional receiver implemented in the device 100 or may be a receiver which is already present in the device 100, such as a cellular telephone receiver in the case of a cellular telephone, or a Wi-Fi receiver in the case of a router. Accordingly, in some examples, additional receiver hardware may not be required to be added to a device for use as a device in accordance with examples of the present disclosure.

The receiver 105 may in some examples extract amplitude of received wireless signals without using power-intensive components such as oscillators. Oscillators generate the carrier frequency (e.g., the 725 MHz TV carrier or the 2.4 GHz or 5 Hz WiFi carrier frequency), and are typically used at receivers to remove the carrier frequency (down-conversion). The receiver may instead include an analog envelope detector that may remove the carrier frequency of the received wireless signals. Generally, envelope detectors used in example receivers described herein may distinguish between rates of change expected due to a communications signal carried by the wireless signal (e.g., a TV signal or a WiFi signal) and the rates of change expected due to a gesture. Accordingly, examples of suitable envelope detectors described herein have time constants greater than 1/(frequency of change of the communication signal encoded by the wireless signals). For example, TV signals may encode information at a rate of 6 MHz. Human gestures occur generally at a maximum rate of tens of Hertz. Accordingly, an envelope detector used in the receiver 105 detecting gestures via TV signals may have a time constant much greater than 1/(6 MHz), to ensure the encoded TV data is filtered out and amplitude changes due to human gestures remain. Similarly, an envelope detector used in the receiver 105 detecting gestures via WiFi signals ma have a time constant much greater than 1/(2.4 GHz or 5 GHz), to ensure the encoded WiFi data is filtered out and amplitude changes due to human gestures remain. The receiver 105 is then able to provide an indication (e.g., signals and/or stored data) to the classifier 110 of changes in the amplitude of the received wireless signals that may be due to human gestures (e.g., occurring at a rate that is possible for a human gesture).

The classifier 110 may receive the indication of changes in the amplitude of the received wireless signals and may classify the changes as corresponding to a particular gesture. The classifier 110 may accordingly identify a gesture associated with the changes in amplitude extracted by the receives 105, and may provide an indication of the associated gesture to another component of the device 100 (e.g., a processing unit, another application, other logic, etc., not shown in FIG. 1) for use in responding to the associated gesture. In some examples, the classifier 110 may be implemented using an analog circuit encoded with gesture information. In some examples, the classifier 110 may be implemented using a microcontroller. In some examples, the classifier 110 may be implemented using one or more processing unites) and software (e.g., a memory encoded with executable instructions) configured to cause the processing unit(s) to identify a gesture associated with the amplitude changes.

The classifier 110 may include an analog-to-digital converter that may receive analog signals from the receiver 105 and process them into digital signals. An example ADC includes a 10-bit ADC operating at 200 Hz. The classifier 110 may generally perform signal conditioning to remove location dependence, segmentation to identify a time-domain segment of amplitude changes corresponding to a gesture, and classifying the segment to identify the associated gesture.

The classifier 110 may provide signal conditioning to a received wireless signal, such as interpolation, noise filtering, performing a moving average, or any combination thereof. For example, an intermittently transmitted wireless signal, such as a WiFi signal, may include gaps between packet transmissions due to the “bursty” nature of WiFi transmissions. Thus, in an embodiment, the classifier 110 may fill in gaps in the wireless signal transmission. For example, the classifier 110 may sample the wireless signal, and use a 1-D linear interpolation algorithm to fill in the gaps. In an example, the classifier 110 the 1-D linear interpolation algorithm may fill in a gap with up to 1000 evenly-spaced samples. Since the transmission rate of WiFi is usually 2.4 GhZ or 5 Ghz, and the duration of a typical human gesture is generally on the order of hundreds of milliseconds, the interpolation may preserve the gesture information in the wireless signal.

Additionally for signal conditioning, the classifier 110 may apply a low pass filter to the wireless signal to reduce noise and glitches in the wireless signal, while keeping the gesture information intact. For example, the classifier 110 may apply a low pass filter to smooth out fast-varying noise, while keeping slower varying gesture information intact. In an example, the low pass filter may be designed with coefficients equal to a reciprocal of one-tenth of the number of samples of the wireless

The classifier 110 may perform a moving average over a particular time window. In an example, the moving average window may be an time from 300 ms to 320 ms. The moving average may reduce or remove bias caused by environmental factors, such as user location, distance between a transmitter and a the antennae 115, and/or environmental objects in the vicinity that may impact an amplitude of the wireless signal. The classifier 110 may subtract the moving average from each sample returned, from the ADC, which may normalize the received signal. This may remove location dependence, for example, the overall amplitude of the signal changes may be different depending on where a user starts and stops the gesture (e.g., getting closer or further away from the receiver). In some, examples, the classifier 110 and/or the receiver 105 may utilize signals from other sensors on the device (e.g., accelerometers, GPS signals) to adjust the amplitude changes based on other motion of the gesture source if the user is walking or running).

The classifier 110 may provide segmentation to identify a time segment of samples which may correspond to a gesture. Generally, the classifier 110 may utilize amplitude changes to detect the start and end of a gesture. For example, the classifier 110 may compute a derivative of the received signal, e.g., the difference between the current and the previous sample. When this difference rises above a threshold e.g., the classifier may detect the beginning of a gesture. In some embodiments, the threshold may be set to an absolute amplitude value. In one example, the threshold may be set to 17.5 mV. In other embodiments, the threshold may be set based on relative amplitude values. For example, the threshold may be set to 1.5 times the mean of the wireless signal channel samples, (e.g., after signal conditioning). Similarly when this difference falls below the same threshold, the classifier 110 may detect the end of the gesture. Without being bound by the theory, the use of the derivative operation to detect the beginning and end of a gesture generally works because changes caused by a gesture tend to be high. This results in large differences between adjacent samples, which the classifier 110 can use for segmentation.

Moreover, in comparison to ambient human motion such as walking and running, the changes between adjacent samples tend to be higher during intentional gestures closer to the device. Thus, the classifier 100 may perform processing on the detected segments to reduce a false positive: rate, such as a segmentation procedure, a constructive and destructive interference procedure, detection of a single peak above a second threshold, or any combination thereof. For example, the difference between adjacent samples may prematurely drop below the threshold before the end of the gesture. The difference, between adjacent samples may then rise back up soon afterward, creating multiple close-by segments. To avoid this being detected as multiple gestures, the classifier 110 may combine any two segments that occur within a specified time (e.g., 75 milliseconds in one example).

For the constructive and destructive interference procedure, the classifier 110 may pass each segment (e.g., or combined segment) through multiple constructive and/or destructive interference nodes, which may result in a reliable group of peaks. The classifier 110 may also detect whether changes caused by the gesture result in at least one single large peak that is above the mean noise floor by a second threshold (e.g., one standard deviation, in one example).

The classifier 110 further may classify identified segments as particular gestures. In some examples, the classifier 110 may be programmed to or provided with circuitry to run signal-processing, algorithms such as dynamic time warping to distinguish between the segments and identify the signal pattern for a particular gesture. The known patterns may be stored, for example, in a memory accessible to the classifier 110. In an example, a pull gesture away from the antennae 115 may exhibit a pattern of a decrease in peak magnitudes, while a push gesture toward the antennae 115 may exhibit a pattern of an increase peak magnitude. In another example, a punch gesture toward the antennae 115 may exhibit a pattern of an increase followed by a decrease in peak magnitudes, while a lever gesture toward the antennae 115 may exhibit a peak magnitude pattern of increase-decrease-increase. In another example, the classifier 110 implements rules to distinguish between gestures. The rules may be simple and have low complexity. For example, to classify between a push and a pull gesture, the following rule may be used: if the maximum changes in the signal occur closer to the start of a gesture segment, it is a pull action; otherwise, it is a push action. Accordingly, the classifier 110 may implement a set of if-then statements which may classify the gestures. The if-then statements may be implemented, for example, using a microcontroller, an MSP430 microntroller in some examples.

In some examples, the classifier 110 may not include an analog-to-digital converter, or may not include a high-resolution ADC, e.g., an ADC with 8 or 10 bit resolution as may be used in above-described examples of classification. In some examples, the classifier 110 may instead or additionally include one or more analog circuits for decoding gesture information. Accordingly, the classifier 110 may be implemented using one or more analog circuits that may be able to distinguish between amplitude changes generated by respective gestures.

The device 100 may include a transmitter 135 and receiver 130 for communications. The transmitter 135 and receiver 130 may transmit and receive, for example, cellular, TV, RFID, Wi-Fi, or other wireless signals. The receiver 130, for example, may receive the actual television date encoded by the wireless signals whose amplitudes are analyzed by the receiver 105 and classifier 110 for gesture information. In some examples, the data receiver 130 and the receiver 105 used to receive amplitude information for gesture classification may be implemented using a single receiver.

In some embodiments, the device 100 may receive and interpret gesture information with a barrier layer or layers positioned between the device and the gesture source (e.g., no line of sight). For example, the device 100 may receive and interpret gesture information with clothing such as a pocket, or accessories such as a purse or bag, acting as a line-of-sight barrier between the device and the source of the gesture.

The device 100 may include an energy harvester 120 and power management circuit 125 which may extract power from incoming wireless signals (e.g., RF signals of either TV towers, RFID readers, or WiFi signals). In some examples, the energy harvester 120 may provide sufficient energy to power the receiver 105 and classifier 110. Accordingly, the device may be implemented in RFID tags and ambient RF-powered devices. In other examples, the energy harvester 120 may be implemented using a solar, vibration, thermal, or mechanical harvester. The energy harvester 120 and power management circuit 125 are optional, and may not be present, for example, when the device 100 is implemented using a battery-powered mobile device or plug-in device.

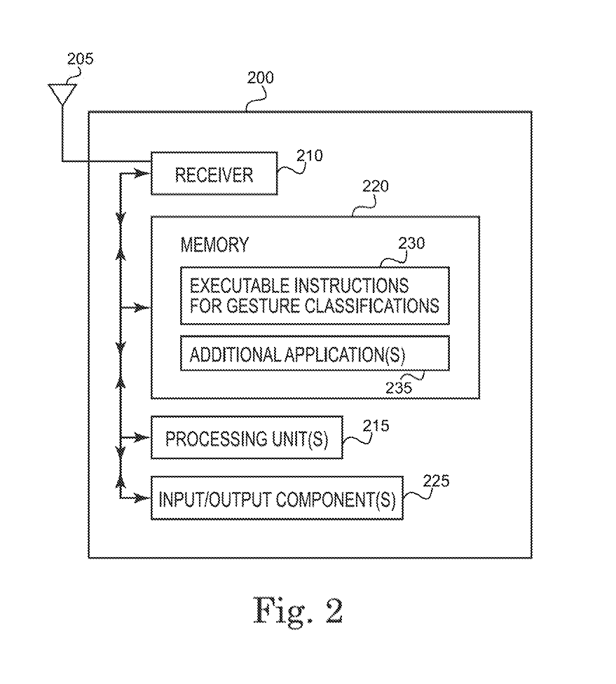

FIG. 2 is a schematic illustration of a device 200 arranged in accordance with examples of the present disclosure. The device 200 may correspond to an implementation of the device 100 of FIG. 1 where the classifier 110 is implemented using software (e.g., one or more processing ti t(S) and memory encoded with executable instruction for gesture classification). The device 200 may be implemented using, a mobile device (e.g., a cellular phone or tablet) without added hardware components in some examples, e.g., without hardware components dedicated to gesture recognition. Instead, in some examples, the device 200 may host a software application (e.g., executable instructions for gesture classification 230) which may decode gesture information from an existing receiver (e.g., receiver 210).

The device 200 may include an antenna 205, which may receive wireless signals (such as cellular signals, TV signals, WiFi signals, etc.). In some examples, the antenna 205 may represent multiple antennas to receive multiple wireless signals, one or more of which may be analyzed for gesture detection. For example, each antenna may be designed to receive signals transmitted within a particular frequency range or ranges, or for a particular purpose (e.g., TV, cellular, WiFi, etc.).

In some examples, the wireless signals may be ambient wireless signals which are already present in the environment of the device 200, such as those transmitted from a base station (e.g., WiFi, TV, cellular, etc.). In some examples, the wireless signals may be transmitted from a dedicated signal source (not shown) or from the device 200, itself, such as via the antenna 205. The wireless signals transmitted from the dedicated signal source or from the device 100 may be for the purpose of signal detection or may be for another purpose (e,g., cellular communications, WiFi communications, or other communications).

The device 200 may further include a receiver 210, coupled to the antenna 205, which may receive the wireless signals and may provide information regarding the amplitude of the signals, or amplitudes of a portion of the signals, to other components of the device 200, such as a processing unit(s) 215 or memory 220. In some embodiments, the receiver 210 may further provide information regarding the phase of the signals to the other components of the device 200, such as a processing unit(s) 215 or memory 220. In some examples, the receiver 210 may be an existing receiver on the device 200 which may already be accustomed to providing channel state information—e.g., full IEEE 802.11 channel state information or RSSI information. The receiver 210 may further receive and provide communication data (e.g., data related to a cellular telephone call) to other components of the device 200. In this manner, a single receiver 210 may be used to provide amplitude information (e.g., of channel state information or RSSI information) for gesture recognition and receive cellular phone communications. Changes in amplitude of the channel state information or RSSI information may be analyzed for each packet in received wireless signals, or selected packets. In some embodiments, the receiver 210 may analyze changes in phase of the channel state information or RSSI information for gesture recognition for each packet or selected packets of received wireless signals.

The device 200 may include one or more processing unit(s) (e.g., processors) and memory 220 (e.g., including, but not limited to, RAM, ROM, flash, SSD, hard drive storage, or combinations thereof). The memory 220 may be encoded with executable instructions for gesture classification 230. The executable instructions for gesture classification 230 may, for example, be implemented as an application loaded on the device 200. The executable instructions for gesture classification 230 may operate together with the processing unit(s) 215 to classify gestures using amplitude information provided from the receiver 210. For example, the executable instructions for gesture classification 230 may perform the functions described relative to the classifier 110 of FIG. 1 (e.g., use stored patterns or implement a set of rules to distinguish between particular gestures). Accordingly, the executable instructions for gesture classification 230 may include a set of rules to distinguish between gestures. In some examples, the memory 220 (or another memory accessible to the device 200) may store gesture signatures, and the executable instructions for gesture classification 230 may compare received amplitude information with the stored gesture signatures to identify one or more gestures.

The device 200 may further include input components and/or output components 225—including, but not limited to, speakers, microphones, keyboards, displays, touch screens, sensors. The device 200 may further include additional application(s) 235 which may be encoded in the memory 220 (or another memory accessible to the device 200). Once a gesture has been decoded in accordance with the executable instructions for gesture classification 230, an indication of the gesture may be provided to one of the additional application(s) 235 (or to an operating system or other portion of the device 200). In this manner, another application 235 or the operating system of the device 200 may provide a response to the gesture.

Any of a variety of responses may he provided, in accordance with the implementation of the operating system and/or additional application 235. Examples include, but are not limited to, zooming in or out a view on a display, muting a ringing phone, selecting a contact from an address list, and raising or lowering an output volume. The response provided may be determined by the gesture classified in accordance with the executable instructions for gesture classification 230.

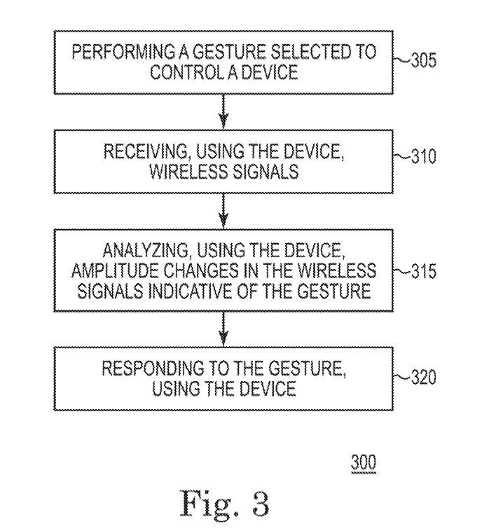

FIG. 3 is a flowchart of a method 300 in accordance with examples of the present disclosure. The method 300 includes performing a gesture selected to control a device 305, receiving, using the device, wireless signals 310, analyzing, using the device, amplitude changes in the wireless signals indicative of the gesture 315, and responding to the gesture, using the device 320. The method 300 is one example, and in other examples not all of the blocks 305-320 may be present, for example responding 320 may be optional. Additional blocks may be included in some examples, such as harvesting power using the device.

In block 305, a gesture may be performed to control a device. For example, the gesture may be performed to control the device 100 of FIG. 1 or the device 200 of FIG. 2. The gesture may generally be a predetermined movement performed in a vicinity of the device. The gesture may be performed by a user (e.g., a human user), or in some examples may be performed by another system (e.g., a robotic system) in the vicinity of the device. The gesture may not involve physical contact (e.g., touch) with the device. The gesture may not involve optical contact (e.g., without use of a camera or image sensor) with the device. The gesture may in some examples be performed while a barrier layer or layers are positioned between the device and the gesture source (e.g., no line-of-sight). For example, clothing such as a pocket, or accessories such as a purse or bag, may be between the device and the source of the gesture. The barrier layer or layers may be opaque or at least partially opaque, obscuring optical contact with the device. Moreover, the barrier layer or layers may be incompatible with resistive or capacitive touchscreen sensing such that touch display interfaces may not be operable through the barrier layer. Nonetheless, examples described herein facilitate control of a device using a gesture without optical or physical contact with the device.

In block 310, the device may receive wireless signals. Examples of receiving wireless signals have been described herein with reference to FIGS. 1 and 2. The wireless signals may be ambient signals, and may be, for example, TV, cellular, WiFi, or RFID signals. In block 315, the device may analyze amplitude changes in the wireless signals indicative of the gesture performed in block 305. Examples of such analysis have been described herein with reference to FIGS. 1 and 2, for example using the classifier 110 of FIG. 1. The wireless signals may be received through a barrier layer (e.g., a pocket or purse), which may be opaque or at least partially opaque. The amplitude changes may include amplitude changes of channel state information, e.g., RSSI information, received by the device. Analyzing the amplitude changes in block 315 may include identifying the gesture made in block 305. In some embodiments, changes in phase of the wireless signals may be analyzed based on the channel state information to detect changes indicative of the gesture.

In block 320, the device may respond to the gesture. Based on what gesture was performed in block 305, the device may provide a particular response. Examples of responses include, but are not limited to, changing a volume, changing a playback track, selecting a contact, silencing an incoming call, or zooming in or out a display. Accordingly, in accordance with examples described herein, devices may be controlled while the are in a pocket, purse, bag, compartment, or other location without visual or touch access to the source of the gesture (e.g., the human user).

Random movement of gesture sources in the environment may also provide amplitude changes in wireless signals. Some of these movements may generate changes which may be classified by classifiers described herein as gestures. To reduce false positives, the method of FIG. 3 may begin with performance of a starting gesture sequence, such as a particular gesture or a combination of gestures (e.g., a sequence of two or more of the same gesture, a sequence of two or more different gestures, or combination thereof), prior to initiation of the method 300 (e.g., and prior to beginning to provide indication of detected gestures to downstream components of the devices). Use of the stalling gesture sequence may in some examples reduce a false positive rate of devices in accordance with examples described herein. For example, the starting gesture sequence may reduce a rate at which the device inadvertently responds to a spurious gesture or other movement in the environment. Classifiers, such as the classifier 110 or the executable instructions for classification 230 of FIG. 2, may be configured not to provide an indication of the detected gesture unless the starting gesture sequence is first detected, and then indications of subsequent gestures detected will be provided. It may be desirable to use gestures for the starting gesture sequence that are less likely to be replicated by random movements. In some examples, a double flick or a lever gesture may serve as the starting gesture sequence.

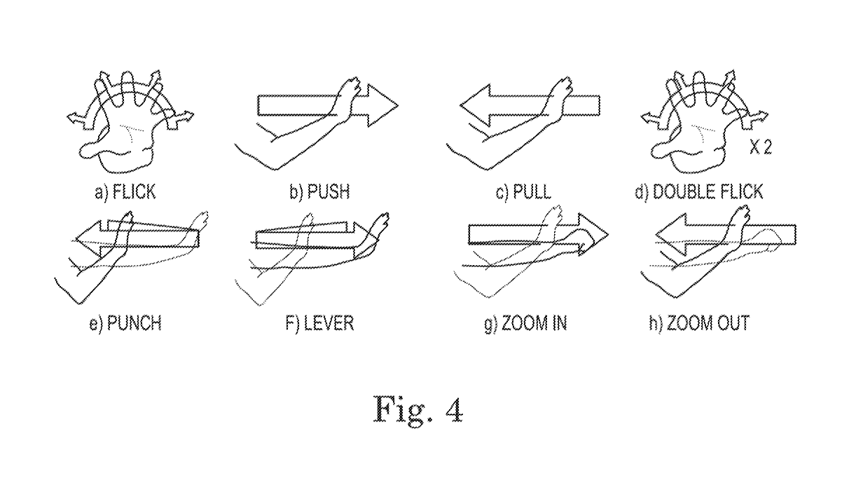

FIG. 4A-H are schematic illustrations of gestures which may be decoded by devices in accordance with examples of the present disclosure. While eight particular gestures are shown, generally any number may be used. Examples of devices described herein will generally include a classifier (e.g., the classifier 110 of FIG. 1) which can discriminate between a library of gestures—in one example, the gestures of FIG. 4A-H, however other libraries of gestates that include greater or fewer numbers of gestures, and/or different gestures, may also be used.

FIG. 4A is a flick gesture. The flick gesture generally refers to a hand gesture where the fingers are initially closed and then are wide open. FIG. 4B is a push gesture, where a user's hand is pushed forward, away from the user. FIG. 4C is a pull gesture, where a user's hand is pulled toward the user. FIG. 4D is a double flick gesture, generally referring to as repeated flick of FIG. 4A. FIG. 4E is a punch gesture, generally referring to as user extending their hand out away from the user and back. FIG. 4F is a lever gesture, generally referring to a user pulling their hand back toward them and then returning to an extended position. FIG. 4G is a zoom in gesture, generally referring to a gesture where a user moves their hand from a semi-extended position further forward (e.g., away from the user). FIG. 4H is a zoom out gesture, generally referring to a gesture where a user moves their hand from an extended position to a semi-extended position closer to the user.

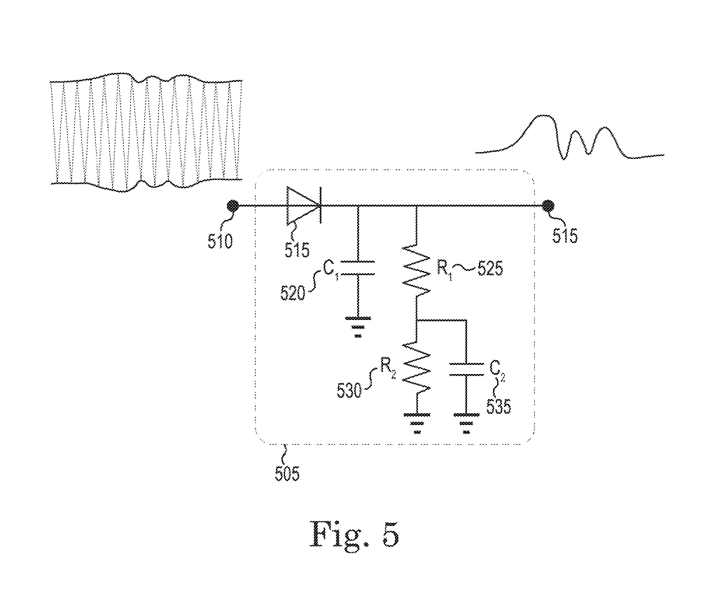

FIG. 5 is a schematic illustration of an example receiver arranged in accordance with examples of the present disclosure. The receiver 500 may be used to implement all or portions of the receiver 105 of FIG. 1 or the receiver 210 of FIG. 2. The receiver 500 may remove a carrier frequency of received wireless signals and extract amplitude information (e.g., amplitude of the received wireless signals). The receiver 500 includes an envelope detector 505 which is implemented using passive analog components (e.g., diodes, resistors, and capacitors), and therefore reduces or minimizes an amount of power needed to extract amplitude information.

Wireless signals may be received at port 510, which may be coupled, for example, to an antenna. The diode 515 is coupled to the port 510. Generally a diode acts as a switch allowing current to flow in the forward direction but not in the revers. Accordingly, the diode 515 provides charge to the capacitor C₁ 520 when the input voltage at the port 510 is greater than the voltage at the capacitor 520. On the other hand, when the input voltage at the port 510 is lower than the voltage at the capacitor 520, the diode 515 may not provide charge and the resistors R₁ 525 and R₂ 530, connected in series and together in parallel with the capacitor 520, may dissipate the energy stored on the capacitor 520, lowering its voltage. The rate of voltage drop is related to the product C₁*(R₁+R₂). Thus, by choosing appropriate values of R₁, R₂ and C₁, the rate at which the signal's envelope is tracked can be selected.

In this manner, the envelope detector 505 may act as a low-pass filter, smoothing out the carrier frequency from constant-wave transmissions. The capacitor C₂ 535, connected in parallel across resistor R₂ may aid with this filtering. Note that the envelope detector 505 does not remove the amplitude variations caused by gestures (e.g., human gestures). This is generally because the envelope detector 505 is tuned to track the variations caused by human motion which happen at a rate orders of magnitude lower than the carrier frequency. An illustration of example incoming wireless signals is shown in FIG. 5 above the port 510, illustrating the envelope, which includes variations due to a gesture, and the carrier wave shown within the envelope. At the output port 515 of the envelope detector 505, an example illustration of the filtered signal is shown, including the variations in the envelope which may be caused by a gesture source. The output of the envelope detector 505 may be provided to a classifier, e.g., the classifier 110 of FIG. 1. For example, the output of the envelope detector 505 may in some examples be provided to an analog-to-digital converter for digital processing of the amplitude information. In other examples, the output of the envelope detector 505 may be provided to an analog circuit which is arranged to directly decode gesture information.

For faster-changing wireless signals (e.g., TV transmissions), the signals may have information encoded in them and hence have fast-varying amplitudes. For example, ATSC TV transmissions encode information using 8VSB modulation, which changes the instantaneous amplitude of the signal. In some examples, the receiver, e.g., the receiver 105 of FIG. 1 or 210 of FIG. 2, may decode the TV transmissions and estimate the channel parameters to extract the amplitude changes that are due to human gestures. This approach, however, may be undesirable on a power-constrained device. Note that amplitude changes due to human gestures happen at a much lower rate than the changes in the wireless signals due to TV transmissions or other communications signals. Accordingly, receivers, such as the receiver 105 of FIG. 1, 210 of FIG. 2, or 500 of FIG. 5, may leverage this difference in the rates to separate the two effects. For example, TV signals encode information at a rate of 6 MHz, but human gestures occur generally at a maximum rate of tens of Hertz. The envelope detector 505 may distinguish between these rates. For example, the component values may be selected such that the time constant of the envelope detector 505 is generally much greater than 1/6 MHz. This may ensure that the encoded TV data is filtered out, leaving only the amplitude changes that are due to gestures.

Accordingly, a time constant of the envelope detector 505 may be selected to be greater than 1/(frequency of data transmission in the wireless signals), but less than 1/(frequency of expected gesture). In this manner, appropriate amplitude information may be extracted by the envelope detector 505 which is related to gestures.

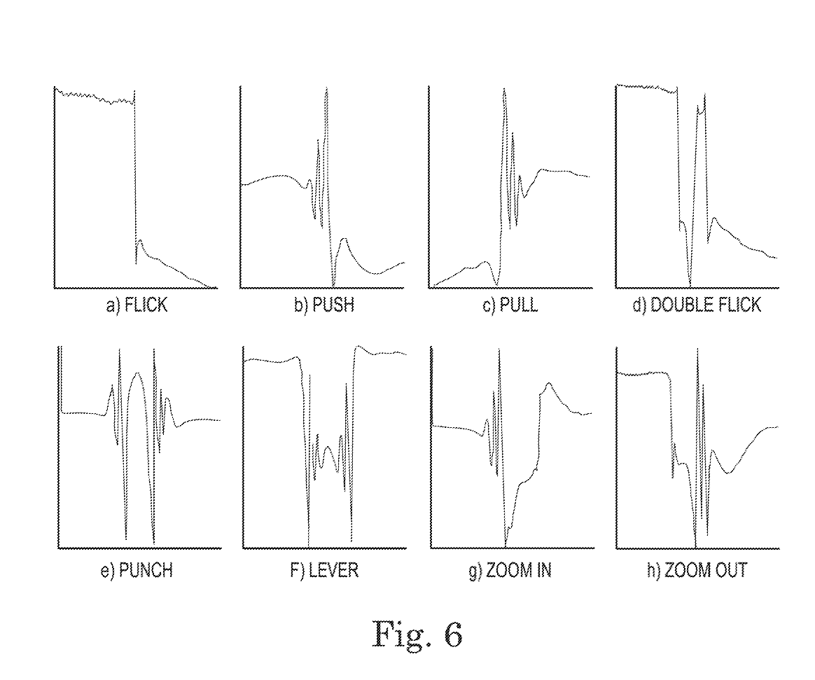

FIG. 6A-H are illustrations of amplitude information associated with gestures extracted from wireless signals in accordance with examples of the present disclosure. The amplitude information shown in FIG. 6A-H may be provided by the receiver 105 of FIG. 1, 210 of FIG. 2, and/or 500 of FIG. 5. For example, the amplitude information shown in FIG. 6A-H may be provided at an output of the envelope detector 505 of FIG. 5 for each of the gestures shown. FIG. 6A illustrates amplitude information associated with a flick gesture. A change from a high to a low amplitude occurs mid-gesture. FIG. 6B illustrates amplitude information associated with a push gesture. An amplitude transitions from a high to a low amplitude, with a spike mid-gesture. FIG. 6C illustrates amplitude information associated with a pull gesture. An amplitude transitions from a low to a high amplitude, with a spike mid-gesture. FIG. 6D illustrates amplitude information associated with a double flick gesture. An amplitude double-transitions from a high to a low amplitude. FIG. 6E illustrates amplitude information associated with a punch gesture. There are generally two spikes in the amplitude information, with a high level in the middle. FIG. 6F illustrates amplitude information associated with a lever gesture. There are generally two spikes in the amplitude information, with a lower level in the middle. FIG. 6G illustrates amplitude information associated with a zoom in gesture. A spike in the amplitude information is followed by a slower increase in amplitude. FIG. 6H illustrates amplitude information associated with a zoom out gesture. A drop in amplitude is followed by a spike.

The amplitude information shown in FIG. 6A-H may be provided by receivers described herein, and may be provided at an output of the envelope detector 505 of FIG. 5, for example. Embodiments of classifiers, e.g., the classifier 110 of FIG. 1 or the executable instructions for classification 230 of FIG. 2, described herein are able to distinguish between the amplitude information sets shown in FIG. 6A-H (or another library in the case of different gestures). In some examples, a representation of the information shown in FIG. 6A-H (e.g., signatures) may be stored, and incoming amplitude information may be compared to the stored signatures to identify gestures. In other examples, time-domain analysis is used, and rules may be established to distinguish between gestures.

An RF source generally transmits wireless signals having a frequency f, such that the transmitted signal may be expressed as:

sinft sinf_{c}t where f_{c} is the transmitter's center frequency.

When a gesture source moves toward the receiver, it generally creates a Doppler shift f_{d}, such that the receiver receives a signal which may be expressed as:

sin ft sin f_{c}t+sin ft sin(f_{c}+f_{d})t

Such that the received signal is a linear combination of the signal from the RF source and the Doppler-shifted signal due to the gesture. By way of example to aid in understanding, assuming the gesture source's reflection has a same signal strength as the direct signal, the above equation simplifies to:

sinft (sinf_{c}t+sin(f_{c}+f_{d})t), which equates to

2 sin ft cos(f_{d}t/2)sin(f_{c}+f_{d}/2)t

Example receivers may use oscillators tuned to the center frequency f_{c} and extract the Doppler frequency term f_{d} from the last sinusoid term in the above equation. However, example receivers described herein may not include oscillators. For example, the envelope detector approach shown in FIG. 5 may not he as frequency-selective as an oscillator. The envelope detector 505 generally tracks the envelope of the fastest-changing signal and removes it. Accordingly, referencing the equation above, the envelope detector 505 of FIG. 5 may remove the last sinusoid term, and the output of the envelope detector 505 may be expressed as:

2 sin ft cos(f_{d}t/2)=sin(f+f_{d}/2)t+sin(f−f_{d}/2)t

If an FFT were used to classify gestures from amplitude information having the above equation, energy may be seen in both the positive and negative frequencies. Accordingly, the receiver using an FFT may be unable to distinguish between a push and a pull gesture, or other gestures which are opposite in their direction.

Accordingly, examples of classifiers described herein, such as the classifier 110 of FIG. 1 and the executable instructions for gesture classification 230 of FIG. 2, utilize amplitude and timing information to classify gestures. For example, consider the push and pull gestures of FIG. 3B and C and FIG. 6B and C. As the user moves her arm towards the receiver, the changes in magnitude increase, as the arm gets closer to the receiver. This is because the reflections from the user's arm undergo lower attenuations as the arm gets closer. When the user moves her arm away from the receiver, the changes in the magnitude decrease with time. Thus, the changes in the time-domain signal can be uniquely mapped to the push and the pull gestures as shown in FIGS. 6B and 6C. Examples of classifiers described herein also leverage timing information to classify gestures. For example, the wireless changes created by the flick gesture, as shown in FIG. 6A, occurs for a shorter period of time compared to a push or a pull gesture (FIGS. 6B and 6C). Using this timing information, the classifiers can distinguish between these three gestures. Examples of time-domain classification including signal conditioning, segmentation, and classification have been described above with reference to FIGS. 1 and 2.

As described above with reference to FIG. 1, in some examples, a classifier may be implemented using a microcontroller, which may implement rules (e.g., instructions) for distinguishing between gestures. One set of rules that may be used to distinguish between the gestures of FIG. 4A-G (e.g., between the amplitude changes shown in FIGS. 6A-6), may be represented in pseudocode as follows:

```
[length,maxIndex]←GETGESTURE( )
g0←CLASSIFYSUBGESTURE(length,maxIndex)
[length,maxIndex]←GETGESTURE( )
g1←CLASSIFYSUBGESTURE(length,maxIndex)
if (g0 = FLICK and g1 = FLICK) then return D_FLICK
else if (g0 = FLICK and g1 = PULL) then return Z_OUT
else if (g0 = PUSH and g1 = FLICK) then return Z_IN
else if (g0 = PUSH and g1 = PULL) then return PUNCH
else if (g0 = PULL and g1 = PUSH) then return LEVER
else if (g0 = FLICK and g1 = NULL then return FLICK
else if (g0 = PUSH and g1 = NULL) then return PUSH
else if (g0 = PULL and g1 = NULL) then return PULL
end if
function CLASSIFYSUBGESTURE(length,maxIndex)
    if (length < FLICKLENGTH) then return FLICK
    else if (maxIndex < length/2) then return PUSH
    else if (maxIndex ≧ length/2) then return PULL
end if
end function
```

The above pseudocode implements a classifier that has segmented each gesture into two subgestures, each having a particular temporal length and a maximum amplitude within the length, with the maximum amplitude occurring at a particular time. The classifier (e.g., the classifier 110 of FIG. 1 or the executable instructions for classification 230 of FIG. 2), may identify a FLICK subgesture when the length of the gesture is less than a threshold FLICKLENGTH. Otherwise, the classifier may consider whether the maximum amplitude is closer to the beginning or the end of the subgesture. If closer to the beginning, the subgesture may be classified as a PUSH subgesture. If closer to the end, the subgesture may be classified as a PULL gesture.

The remaining gestures shown in FIG. 4A-H are viewed as combinations of three subgestures—Flick, Push, and Pull. If two adjacent subgestures are classified as FLICK, the classifier may identify a DOUBLEFLICK gesture. If a first subgesture is classified as FLICK and a second as PULL, then a ZOOM OUT gesture may be identified. If a first subgesture is classified as PUSH and a second as FLICK, then a ZOOM IN gesture may be identified. If a first subgesture is classified as PUSH and a second as PULL, then a PUNCH may be identified. If a first subgesture is classified as PULL and a second as PUSH, then a LEVER gesture may be identified. If a FLICK, PUSH, or PULL subgesture is followed b an interval with no gesture, the FLICK, PUSH, or PULL gesture may itself be identified. The pseudocode described above may be implemented as an instruction set on a microcontroller in some examples.

In other examples classifiers described herein may be implemented using analog circuits specifically designed to distinguish between amplitude changes associated with particular gestures. The use of analog circuits may be desirable, for example to reduce power and to avoid a need for an ADC, or reduce the requirements for any needed ADC.

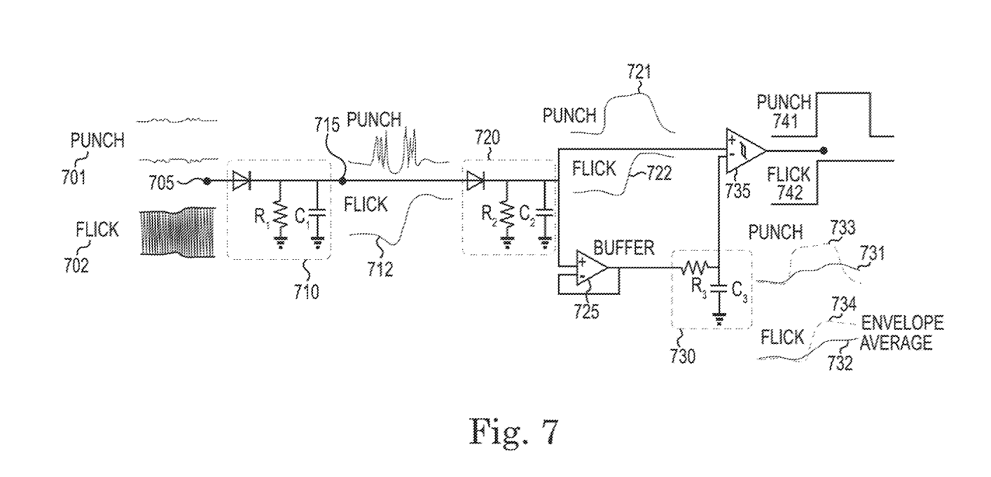

FIG. 7 is a schematic illustration of an analog circuit that can distinguish between two gestures, arranged in accordance with examples of the present disclosure. The circuit 700 may distinguish between the PUNCH and FLICK gestures described herein. Similar circuits may be provided to distinguish between the PULL and FLICK gestures, or the PUNCH and PULL gestures, for example. The circuit 700 includes first envelope detector 710, a second envelope detector 720, an averaging circuit 730, and a comparator 735. The first envelope detector functions to remove the carrier frequency of received wireless signals, and may in some examples be implemented using the envelope detector 505 of FIG. 5. The second envelope detector 720 may track time-domain changes caused by the gestures at a slow rate. The averaging circuit 730 may compute the slow-moving average of the second envelope detector. The comparator 735 may output bits, such that the bit sequence is indicative of a PUNCH or a FLICK gesture.

A PUNCH signal 701 is illustrated arriving at an input port 705, for example, from an antenna. A received FLICK signal 702 is also illustrated. Note that, although both are shown for purposes of illustration, only one would be received at a time. The signals 701 and 702 include an envelope and a carrier signal. At an output of the envelope detector 710, the signals no longer have the carrier frequency, and are illustrated as PUNCH signal 711 and FLCK signal 712. The second envelope detector 720 tracks the signal at a much lower rate, and hence at the output of the second envelope detector 720, the PUNCH signal 721 looks like an increase and then a decrease in the amplitude levels (e.g., a step); this corresponds to starting the gesture source (e.g., arm) at an initial state and then bringing it back to the same state. The FLICK signal 722, on the other hand, is a transition between two reflection states: one where the fingers are closed to another where the fingers are wide open. Accordingly, the FLICK signal 722 appears as a transition (e.g., step).

The averaging circuit 730 and the comparator 735 facilitate generation of a bit sequence that is unique for either gesture. For example, the averaging circuit 730 further averages the signals 721 and 722 to create the averaged signals 731 and 732. For ease of comparison, the signals 721 and 722 are superimposed with the averaged signals as signals 733 and 734. The comparator 735 receives the signals 721 and 722 and their averages 731 and 732 as inputs, and outputs a bit whenever the signal is greater than the average and a ‘0’ bit otherwise. Thus, the comparator 735 outputs unique set of bit patterns for the two gestures (010, signal 741, and 011, signal 742, as shown in FIG. 5). Thus, the circuit 700 classifies these PUNCH and FLICK gestures.

Note that the comparator 735 may be considered a one-bit ADC; it has minimal resolution and hence consumes a low amount of power. Second, the parameters in the circuit 700 are chosen to account for timing information in the specific gestures. Thus, it may be less likely that random human motions would trigger the same bit patterns.

### EXAMPLES

The following examples are provided to facilitate understanding of the embodiments described herein. The examples are not intended to be limiting, and are provided by way of example—not all prototypes which may have been made or investigated are described here.

Example prototypes were implemented on two-layer printed circuit boards (PCBs) using off-the-shelf commercial circuit components. The PCBs were designed using the Altium design software and manufactured by Sunstone Circuits. A pluggable gesture recognition component included a low-power microcontroller (MSP430F5310 by Texas Instruments) and an interface to plug in wireless receivers. The microcontroller, for example, may be used to implement the classifier 110 of FIG. 1. The prototype also features a UART interface to send data to a computer for debugging purposes as well as low-power LEDs. The output from the wireless receivers is sampled by an ADC at a frequency of 200 Hz (i.e., generating a digital sample every 5 ms). The prototypes generally used 10 bits of resolution at the ADC, however, other resolutions could and have been used.

To minimize power consumption, the microcontroller sleeps most of the time. The ADC wakes up the microcontroller to deliver digital samples every 5 ms. The microcontroller processes these samples before going back to sleep mode. The maximum time spent by the microcontroller processing a digital sample is 280 μs in one example.

A prototype for the analog gesture encoding circuit described with reference to FIG. 7 was implemented by incorporating additional components into wireless receivers. For example, an ultra-low power comparator, TS881, was used to implement the comparator 735 and the buffer 725 was implemented using an ultra-low power operational amplifier (ISL28194). The output of the comparator is fed to the digital input-output pin of the microcontroller. The capacitor and resistor values R1, R2, R3, C1, C2 and C3 shown in FIG. 7 were set to 470 kΩ, 56 MΩ, 20 kΩ, 0.47 μF, 22 μF and 100 μF respectively.

For the ADC-based prototype, the 10-bit ADC continuously sampling at 200 Hz consumes 23.867 μW. The micro-controller consumes 3.09 μW for signal conditioning and gesture segmentation and 1.95 μW for gesture classification; the average power consumption is 26.96 μW when no gestures are present and 28.91 μW when classifying 15 gestures per minute. In the analog-based prototype, the hardware components, the buffer and the comparator consume a total of 0.97 μW. The micro-controller consumes 3.6 μW in sleep mode (e.g., no bit transitions at the comparator's output). The average power consumption for the analog-based system is 4.57 μW when no gestures are present and 5.85 μW when classifying 15 gestures per minute.

The ADC-based prototypes utilized a 10-bit ADC operating at 200 Hz.

In one example, a prototype was placed in the decoding range of a USRP-based RFID reader for use as a source of wireless signals. Gestures were detected and classified using a microcontroller as described above with reference to FIG. 1 and the pseudocode described herein. Average accuracy of gesture detection was 97% with a standard deviation of 2.51% when classifying among the eight gestures shown in FIG. 4.

In another example, a prototype was tuned to harvest power and extract gesture information from TV signals in the 50 MHz band centered at 725 MHz. Gestures were detected and classified using a microcontroller as described above with reference to FIG. 1 and the pseudocode described herein. Average accuracy of gesture detection was 94.4%.

When the prototype receiver did not use a starting gesture sequence in one example, a false positive rate was about 11.1 per hour over a 24 hour period. The average number was reduced to 1.46 per hour when a single flick gesture was used as a starting gesture sequence. When a double flick gesture was used as a starting gesture sequence, the false positive rate was reduced to 0.083 events per hour.

An elapsed time was measured between a time a user finished a gesture and when the microcontroller classifies the gesture. A maximum response time across the experiment was 80 μs. The variance of the response time was between 2-3 μs. The number of instructions ran by the microcontroller for all responses was the same, but the variability arose from the 1 MHz operational frequency of the microcontroller itself.

A prototype was evaluated using the analog gesture decoding circuit of FIG. 7. The punch gesture was always classified correctly across 25 repetitions of the punch and flick gestures. The flick gesture was misclassified 2 of the 25 times. Average accuracy across the two gestures was about 96%.

In one example, a hardware prototype was integrated with a Nexus S smartphone and gesture recognition as performed “through-the-pocket”. The prototype was connected to the phone via a USB/UART FTDI serial adapter. Since the Nexus S cannot source power to the FTDI adapter via the USB, a USB Y-Cable was used to power the adapter. The Nexus S does not directly provide software support for USB On-The-Go, so Cyanogenmod was used instead, which is a custom Android Rom to provide this support.

The smartphone prototype was evaluated by placing the device in the pocket of a jacket that the user was wearing. The user then performed the eight gestures in FIG. 4 on the same x-y plane as the phone, 20 times each. Results showed that the mean accuracy across gestures was about 92.5%. In comparison to the previous scenarios, the classification accuracy here is a bit lower. This may be because, in these experiments, the device is obscured behind the jacket fabric and hence experiences higher signal attenuation. Also, the prototype was limited to scenarios where the user is stationary and did not walk/run while performing the gestures. In other examples, other low-power sensors such as accelerometers on the phone may be used to detect and adjust for these scenarios.

From the foregoing it will be appreciated that, although specific embodiments of the disclosure have been described herein for purposes of illustration, various modifications may be made without deviating from the spirit and scope of the disclosure.

1. A method comprising:
receiving, using a device, wireless signals after a gesture selected to control the device is performed;
analyzing, using the device, magnitude changes in amplitude of the wireless signals indicative of the gesture;
identifying the gesture based, at least in part, on the magnitude changes in amplitude in the wireless signals; and
responding to the gesture, using the device.

2. (canceled)

3. The method of claim 1, wherein the wireless signals include radio frequency signals, sound signals, or combinations thereof.

4-5. (canceled)

6. The method of claim 1, wherein the receiving comprises receiving wireless signals through a harrier layer which is not in contact with a source of the gesture, and wherein the barrier layer is at least partially opaque.

7. The method of claim 1, wherein responding comprises changing a volume, changing a playback track, selecting a contact, silencing an incoming call, or combinations thereof.

8. The method of claim 1, wherein the amplitude changes in the wireless signals comprise amplitude changes in channel state information received by the device.

9-10. (canceled)

11. The method of claim 1, wherein the gesture comprises a swipe, an up gesture, a down gesture, a push gesture, a pull gesture, a flick, a double flick, a punch, a lever gesture, a zoom-in gesture, as zoom-out gesture, or combinations thereof.

12. A device comprising:
a receiver configured to receive wireless signals and provide an indication, of magnitude changes of amplitude of the wireless signals over time;
a classifier configured to identify an associated gesture based on the indication of the magnitude changes of amplitude of the wireless signals over time the classifier further configured to provide an indication of the associated gesture; and
at least one processing unit configured to provide a response to the indication of the associated gesture.

13. The device of claim 12, wherein the classifier comprises at least one of an analog circuit encoded with gesture information, a microcontroller, and a software application loaded on the device and configured to receive the indication from the receiver.

14. (canceled)

15. The device of claim 12, wherein the receiver comprises an envelope detector.

16. The device of claim 12, further comprising an energy harvester configured to harvest sufficient energy from an environment to power the receiver and the classifier.

17. The device of claim 12, wherein the wireless signals include channel state information.

18. The device of claim 12, wherein the wireless signals comprise radio frequency signals.

19. The device of claim 12, wherein the associated gesture comprises a swipe, an up gesture, a down gesture, a push gesture, a pull gesture, a flick, a double flick, a punch, a lever gesture, a zoom-in gesture, a zoom-out gesture, or combinations thereof.

20. The device of claim 12, wherein the receiver comprises a cellular telephone receiver.

21. (canceled)

22. A device comprising:
a receiver configured to extract an amplitude of a wireless signal over time;
a classifier configured to detect changes in the amplitude of the wireless signal over time, the classifier further configured to identify a gesture corresponding to the changes in the amplitude of the wireless signal over time.

23. The device of claim 22, wherein the classifier is configured to condition the amplitude of the wireless signal over time.

24. The device of claim 23, wherein the classifier is configured to condition the amplitude of the wireless signal over time comprises the classifier configured to interpolate between gaps in the amplitude of the signal over time, apply a low pass filter to the amplitude of the signal over time, subtract a windowed moving average of the amplitude of the signal over time, or any combination thereof.

25. The device of claim 24, wherein the classifier is configured to interpolate between gaps in the amplitude of the signal over time comprises application of a 1-D linear interpolation algorithm.

26-29. (canceled)

30. The device of claim 22, wherein the receiver is configured to extract the amplitude of the wireless signal over time comprises the receiver configured to detect the amplitude from channel state information or received signal strength information.

31. The device of claim 30, wherein the classifier is further configured to detect changes in phase of the wireless signal over time from the channel site information of the received signal strength information, wherein the classifier is further configured to identify the gesture corresponding to the changes in the phase of the wireless signal over time.

32-34. (canceled)

35. The device of claim 22, further comprising a plurality of antennas configured to receive a plurality of wireless signals, wherein the classifier is configured to detect changes in amplitudes of two or more of the plurality of wireless signals over time and to identify a gesture corresponding to the changes in the amplitudes of the two or more of the plurality of wireless signals over time.

36-37. (canceled)
